(19) United States
(12) Patent Application Publication
(10) Pub. No.: US 2024/0219719 A1
(43) Pub. Date: Jul. 4, 2024

(54) OPTICAL SYSTEMS WITH LIGHT CONTROL FILMS

(71) Applicant: 3M INNOVATIVE PROPERTIES COMPANY, St.Paul, MN (US)

(72) Inventors: Daniel S. Bates, Chisago City, MN (US); Craig R. Schardt, Woodbury, MN (US); Jincy Jose, Eagan, MN (US); David A. Rosen, North Saint Paul, MN (US); David G. Freier, St. Paul, MN (US); Stephan J. Pankralz, Eagan, MN (US)

(21) Appl. No.: 18/558,421

(22) PCT Filed: May 5, 2022
(86) PCT No.: PCT/IB2022/054172

§ 371 Date: Nov. 1, 2023

Related U.S. Application Data
(60) Provisional application No. 63/201,722, filed on May 11, 2021.

(51) Int. Cl. G02B 27/01

(52) U.S. Cl. CPC G02B 27/0101; G02B 2027/0118

(57) ABSTRACT

An optical system includes a display, a reflective polarizer, and a glare trap. The glare trap includes a plurality of slats having a length L and a width W, L/W≥10. The slats form a plurality of elongated slots therebetween substantially filled with air. The reflective polarizer has an average optical reflectance of at least 40% for a first polarization state and an average optical transmittance of at least 40% for an orthogonal second polarization state. For each of the first and second polarization states, the glare trap has an average specular optical transmittance of between about 20% to about 80% and an average total optical reflectance of less than about 20%. For at least one wavelength in the visible wavelength range, an optical transmittance of the glare trap includes a first transmittance peak at a first peak angle with a corresponding FWHIM of less than about 30 degrees.

### TECHNICAL FIELD

The disclosure generally relates to optical systems, particularly optical systems for heads-up display systems.

### BACKGROUND

Electronic displays are provided in many applications to render digital information to a viewer. As the automotive industry moves towards more connection and sensors, there is a need to communicate increasingly large amounts of information to the driver. A heads-up display (HUD) displays this information while greatly reducing refocusing the eyes off the roadway. Thus, a viewer may be able to view the displayed information while not losing the ability to view the real world through the HUD. The HUD may be implemented in a variety of surfaces and windows, for example, the front windshield of a vehicle. Thus, for an occupant in the vehicle, vehicle operational information, such as vehicle speed and/or navigation directions, or the like, may be displayed to the occupant on, say, the front windshield accordingly. HUD systems may be situated between the steering wheel and the front of the vehicle, for example, in or at the vicinity of a dash area of the vehicle, to create the information carrying image that is projected onto the windshield to be viewed by the driver. In smaller scale, HUD systems are used as goggle lenses or helmet visors, or in other diverse virtual reality (VR), augmented reality (AR), or mixed reality (MR) applications.

### SUMMARY

Some aspects of the disclosure relate to an optical system including a display, a reflective polarizer, and a glare trap. The optical system is configured to display a virtual image of an image emitted by the display to a viewer after the emitted image is transmitted by the glare trap and at least once reflected and at least once transmitted by the reflective polarizer. The glare trap includes a plurality of spaced apart substantially parallel slats extending along a first direction and arranged along a different second direction, having a length L along the first direction and a width W along the second direction, where L/W≥10. The slats in the plurality of spaced apart substantially parallel slats form a plurality of elongated slots therebetween substantially filled with air. For a light incident at an incident angle of less than about 5 degrees and a visible wavelength range extending from about 420 nm to about 650 nm the reflective polarizer has an average optical reflectance of at least 40% for the incident light having a first polarization state and an average optical transmittance of at least 40% for the incident light having an orthogonal second polarization state, and, for each of the first and second polarization states, the glare trap has an average specular optical transmittance of between about 20% to about 80% and an average total optical reflectance of less than about 20%. For a light incident at an incident angle and for at least one wavelength in the visible wavelength range extending from about +20 nm to about 650 nm, an optical transmittance of the glare trap versus the incident angle in a plane of incidence substantially perpendicular to the first direction includes a first transmittance peak at a first peak angle with a corresponding full width at half maximum of less than about 30 degrees.

Some other aspects of the disclosure relate to a light control film including a plurality of spaced apart substantially parallel light blocking regions extending along a first direction and arranged along an orthogonal second direction. Each light blocking region includes a metal slat extending continuously along the length of the light blocking region. The metal slat has a length L along the first direction and a width W along a width direction of the metal slat, where L/W≥10. The light blocking regions form a plurality of elongated through slots therebetween substantially filled by air. For light incident on the light control film and for at least one wavelength in a visible wavelength range extending from about 420 nm to about 650 nm, an optical transmittance of the light control film versus an incident angle of the incident light in a plane of incidence substantially perpendicular to the first direction includes a first transmittance peak at a first peak angle with a corresponding full width at half maximum of less than about 25 degrees.

Some other aspects of the disclosure relate to a method of making a light control film including steps of providing a sheet of metal having opposing top and bottom major surfaces and forming a plurality of spaced apart substantially parallel elongated through slots in the sheet of metal. The elongated through slots extend along a first direction and are arranged along an orthogonal second direction. Each elongated through slot defines opposing top and bottom open surfaces at the respective opposing top and bottom major surfaces of the sheet of metal. For light incident on the light control film and for at least one wavelength in a visible wavelength range extending from about 420 nm to about 650 nm, an optical transmittance of the light control film versus an incident angle of the incident light in a plane of incidence substantially perpendicular to the first direction includes a first transmittance peak at a first peak angle with a corresponding full width at half maximum of less than about 25 degrees.

Other aspects of the disclosure relate to a heads-up display including an optical system according to one or more embodiments of the disclosure, and a front windshield of a vehicle. When an image is emitted by a display of the optical system, the optical system transmits an emitted image toward the front windshield, the front windshield reflects a transmitted image toward a viewer in the vehicle, and the viewer views a virtual image of the emitted image.

Some other aspects of the disclosure relate to a heads-up display (HUD) including a display, a reflective polarizer, and a glare trap. The HUD is configured to display a virtual image of an image emitted by the display to a viewer after the emitted image is transmitted by the glare trap and at least once reflected and at least once transmitted by the reflective polarizer. The HUD includes an optic axis extending between the display and the viewer. The glare trap is configured to be positioned so that the emitted image propagates a distance D along the optic axis between the glare trap and the viewer. The glare trap includes a plurality of spaced apart substantially parallel metal slats extending along a first direction and is arranged along a different second direction. Each slat has a width W along the second direction and a thickness H along a third direction orthogonal to the first and second directions, wherein H in units of mm is not greater than:

$$n \frac{3 \times 1 {0}^{- 4} \cdot D - W}{ϕ}$$

and is not less than:

$$n \frac{W}{0.35}$$

where n is an index of refraction of a material substantially filling the spaces between the slats, ¢ is a half of a field angle of an edge of the virtual image in units of radians, and D and W are in mm.

Other embodiments relate to a vehicle including an optical system according to one or more embodiments of the disclosure.

### BRIEF DESCRIPTION OF DRAWINGS

The various aspects of the disclosure will be discussed in greater detail with reference to the accompanying figures where,

FIG. 1 schematically shows a heads-up display system including an optical system according to some embodiments of the disclosure:

FIG. 2 schematically shows the construction of a light control film according to some embodiments of the disclosure:

FIG. 3 schematically shows light substantially normally incident on a reflective polarizer embedded in a windshield of a vehicle:

FIG. 4 schematically shows light incident at an incident angle on a reflective polarizer of an optical system:

FIG. 5 schematically shows light incident at an incident angle on a light control film of an optical system:

FIG. 6 schematically shows a vehicle including an optical system according to one or more aspects of the disclosure:

FIG. 7 schematically shows the construction of a reflective polarizer of an optical system according to some embodiments:

FIG. 8 schematically shows a glare trap with slats secured to a frame according to some embodiments of the disclosure:

FIGS. 9A-9C schematically show a glare trap including reflection reducing treatment on one or more surfaces of the slats according to some embodiments of the disclosure:

FIGS. 10-12 graphically represent the optical transmittance of the light control film versus the incident angle of light incident on the light control film according to different embodiments:

FIGS. 13A & 13B graphically represent the optical transmittance and optical reflectance of treated and untreated light control films, respectively, over a visible wavelength range:

FIG. 14 graphically represents the normalized optical transmittance of the light control film versus the incident angle of light incident on the light control film according to some embodiments:

FIG. 15A-15C schematically show the construction of a light control film including a unitary metal sheet according to some embodiments:

FIG. 16 schematically shows the construction of a glare trap according to some other embodiments of the disclosure:

FIG. 17 schematically shows the construction of a glare trap being curved along at least one direction: and

FIG. 18 schematically shows a different construction of a glare trap according to some embodiments.

The figures are not necessarily to scale. Like numbers used in the figures refer to like components. However, it will be understood that the use of a number to refer to a component in a given figure is not intended to limit the component in another figure labelled with the same number.

### DETAILED DESCRIPTION OF ILLUSTRATIVE EMBODIMENTS

In the following description, reference is made to the accompanying drawings that form a part hereof and in which various embodiments are shown by way of illustration. It is to be understood that other embodiments are contemplated and may be made without departing from the scope or spirit of the present description. The following detailed description, therefore, is not to be taken in a limiting sense.

The term heads-up display (HUD) is used herein to refer to such display systems, whether employed in the window or windshield of a vehicle such as an aircraft, watercraft, or motor vehicles such as automobiles, trucks, and motorcycles, in smaller scale systems such as goggle lenses or helmet visors, or in other diverse applications.

For instance. HUD systems project an image onto the windshield of a vehicle and allow the viewer (for example, the driver) to view the information in the form of a virtual image. The HUD systems may be configured to display one or more of vehicle operating information such as vehicle speed, navigation information such as directions and/or a map, ambient information such as temperature, radio station or track listing, communication information such as caller information, and road sign information or restrictions such as an effective speed limit, etc. Since potentially large amount of information is displayed it is desirable to have a larger field of view to overlay this information where the viewer is focusing. As the field of view and focal depth increases there is an increase in the volume of the HUD projector due to the optical components. Folded optics designs utilizing a reflective polarizer (such as multilayer optical films (MOF)) may be used to reduce the overall volume of the HUD system. In some cases, stray light (such as that of the sun) may enter the system and be directly reflected back out along the same ray path that the HUD image exits and into the viewer's eyes. Embodiments described herein address these and other challenges.

Some embodiments of the present disclosure describe an optical system including a light control film to mitigate stray light. The light control film may be placed in a location in the optical system such that it allows outgoing light from a display to travel through, but blocks light from certain angles from going into or out of the system. The use of the light control film allows for a reduction in glare viewed by the viewer.

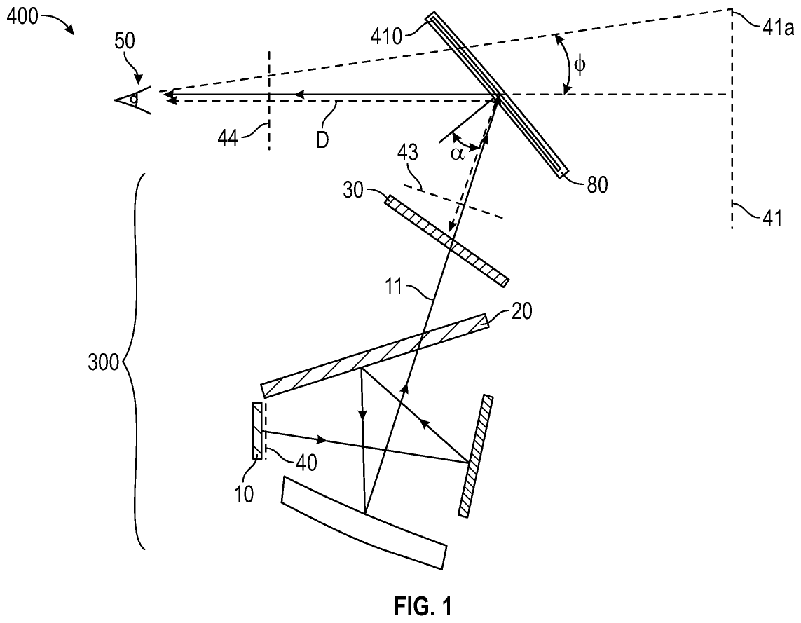

In some embodiments as illustrated in FIG. 1, a heads-up display system (HUD) (400) includes an optical system (300) configured to display a virtual image (41) of an image (40) emitted by the display to a viewer (50). In some aspects, the optical system includes a display (10) that emits an image (40) that is transmitted toward a front windshield (80). The front windshield reflects the transmitted image (43) toward a viewer (50) in the vehicle, and the viewer views a virtual image (41) of the emitted image (40).

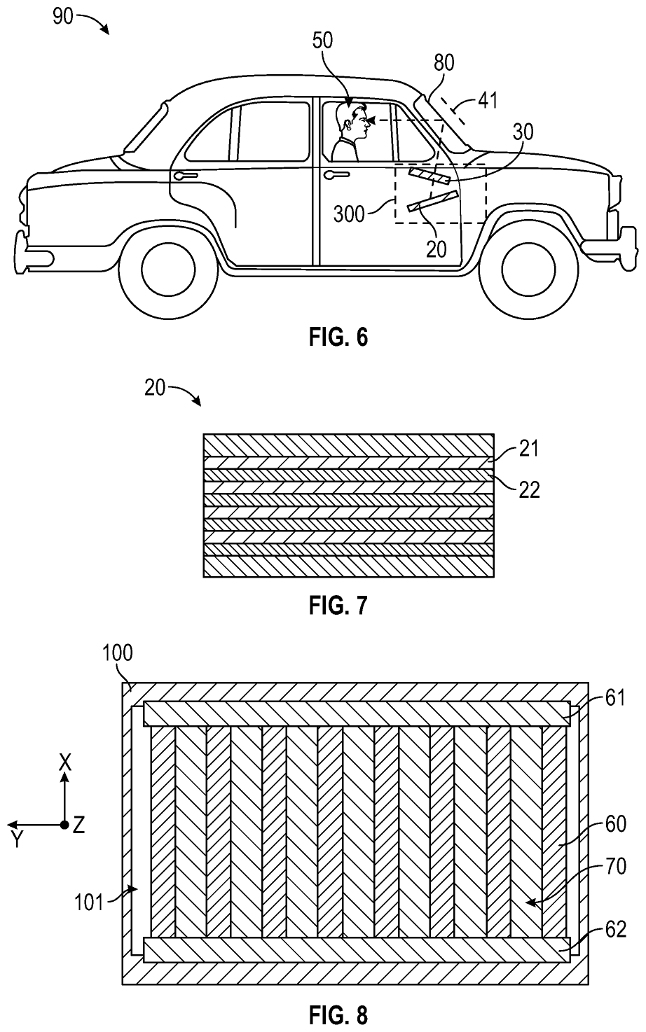

In some aspects, the optical system (300) may further include a first reflective polarizer (20) and a light control film (30). In some embodiments, the light control film (30) may be a glare trap configured to mitigate stray light entering the optical system and reduce glare viewed by the viewer. In some embodiments, the optical system is configured to display the virtual image (41) of the image (40) emitted by the display to the viewer (50) after the emitted image (40) is transmitted by the light control film (30) and at least once reflected and at least once transmitted by the first reflective polarizer (20). FIG. 6 shows a vehicle (90) including a front windshield (80) on which the virtual image (41) is displayed for viewing by a viewer (50), and an optical system (300) configured to display the virtual image (41). In some aspects, the light control film (30) may be configured to be disposed between the first reflective polarizer (20) of the optical system (300) and the front windshield (80) of a vehicle (90).

In some embodiments, the HUD (400) may include a second reflective polarizer (140) configured to receive the transmitted image (43) and reflect a portion (44) of the received image toward the eye (50). In some cases, the front windshield (80) of the vehicle may include the second reflective polarizer (+10) embedded therein. The transmitted image (43) may be incident on the windshield (80) at an incident angle of between about 20 degrees and about 80 degrees, or between about 30 degrees and about 70 degrees, or between about 40 degrees and about 65 degrees, or between about 50 degrees and about 65 degrees, or between about 55 degrees and about 65 degrees.

As shown in FIGS. 3 and 4, for substantially normally incident light (411) and for at least one wavelength between about 420 nm and about 670 nm, the second reflective polarizer (+10) may reflect between about 20% to about 40% of the incident light polarized along a first direction (x1-axis), and may transmit at least 60% of the incident light polarized along an orthogonal second direction (y1-axis). The second reflective polarizer (410) may be configured to receive the transmitted image (43) and reflect a portion (44) of the received image toward the eye (50).

In some aspects, the first and second reflective polarizers (20, 410) may generally include materials which transmit light of a first polarization and which reflect light of a second, different polarization. Reflecting polarizers include, by way of example and not of limitation, diffusely reflecting polarizers, multilayer reflective polarizers, wire-grid reflective polarizers, and cholesteric reflective polarizers. The first and second reflective polarizers (20, 410) may be a wide-band reflective polarizer or a notch reflective polarizer. In other instances, the first and second reflective polarizers (20, 410) may be one or more of an absorbing linear polarizer, a multilayer polymeric reflective polarizer, or a laminate of a reflective polarizer, which substantially transmits light having a first polarization state and substantially reflects light having an orthogonal second polarization state. Substantially uniaxially oriented reflective polarizers are available from 3M Company under the trade designation Advanced Polarizing Film or APF. Other types of multilayer optical film reflective polarizers (e.g., Dual Brightness Enhancement Film or DBEF available from 3M Company) may also be used. Other types of reflective polarizers (e.g., wire-grid polarizers) may also be used.

According to an embodiment as illustrated in FIG. 7, the first reflective polarizer (20) may be a multilayer optical film including a plurality of polymeric layers (21, 22). In some instances, the plurality of polymeric layers (21, 22) may number at least 10 in total. In some instances, the plurality of polymeric layers (21, 22) may number at least 50, or at least 100, or at least 200, or at least 300, or at least 400, or at least 500 in total. Each of the polymeric layers (21, 22) may have an average thickness of less than about 500 nm, or less than about 400 nm, or less than about 300 nm, or less than about 200 nm, or less than about 150 nm. In some embodiments, the number of layers in the first reflective polarizer (20) may be selected to achieve the desired optical properties using the minimum number of layers for reasons of film thickness, flexibility and economy.

In some aspects, as shown in FIG. 4, for a light (42) incident at an incident angle (0) and a visible wavelength range extending from about 420 nm to about 650 nm, and for the incident angle (0) of less than about 5 degrees, the first reflective polarizer (20) may have an average optical reflectance of at least 40%, or at least 50%, or at least 60%, or at least 70%, or at least 80% or at least 90% for the incident light having a first polarization state (x1-axis). In some other aspects, for the incident angle (0) of less than about 5 degrees, the first reflective polarizer (20) may have an average optical transmittance of at least 40%, or at least 50%, or at least 60%, or at least 70%, or at least 80% or at least 90% for the incident light having an orthogonal second polarization state (y1-axis).

As shown in FIG. 1, the HUD includes an optic axis (11) that extends between the display (10) and the viewer (50). The light control film (30) may be configured to be positioned so that the emitted image (40) propagates a distance D along the optic axis (11) between the light control film (30) and the viewer (50).

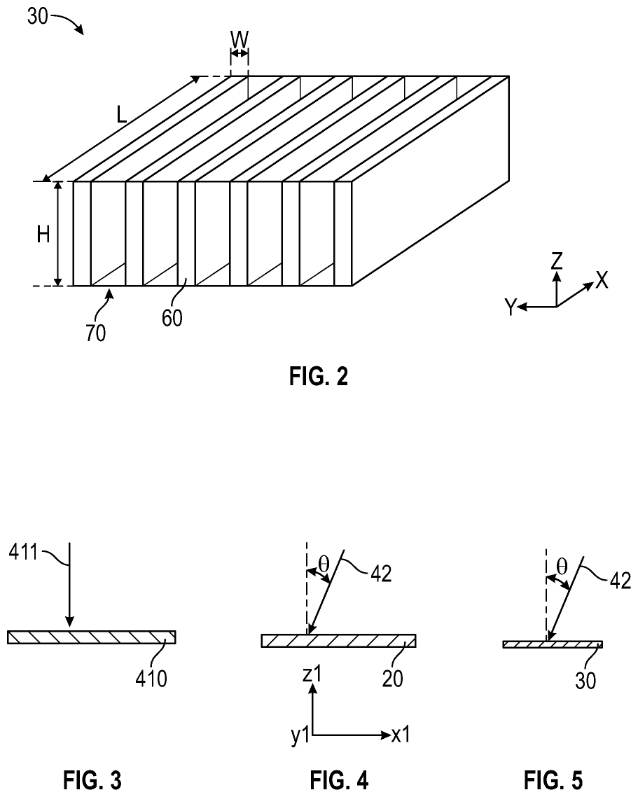

The construction of the light control film (30) according to some embodiments will be explained with reference to FIG. 2. The light control film (30) may include a plurality of spaced apart substantially parallel slats (60) extending along a first direction (x-axis) and arranged along a different second direction (y-axis). Each slat has a length L along the first direction and a width W along the second direction, such that, in some cases. L/W≥10. In some other cases. L/W may be less than about 5000, or less than about 4500, or less than about 4000. For instance, the length L of each slat (60) may be at least 50 mm, or at least 100 mm, or at least 150 mm, or at least 200 mm, or at least 250 mm, or at least 300 mm, or at least 500 mm, or at least 1000 mm. The width W of each slat (60) may be less than about 2 mm, or less than about 1 mm, or less than about 0.8 mm, or less than about 0.6 mm, or less than about 0.4 mm, or less than about 0.3 mm, or less than about 0.2 mm, or less than about 0.15 mm, or less than about 0.1 mm, or less than about 0.05 mm. Each slat further includes a thickness H along a third direction (z-axis) orthogonal to the first (x-axis) and second (y-axis) directions, such that, in some cases. H/W≥2. In some cases. H/W≥3, or, H/W≥4, or H/W≥5, or H/W≥7, or H/W≥10. For instance, thickness H of each slat may be less than about 10 mm, or less than about 8 mm, or less than about 6 mm, or less than about 4 mm, or less than about 3 mm, or less than about 2 mm, or less than about 1.5 mm.

The slats in the plurality of spaced apart substantially parallel slats (60) form a plurality of elongated slots (70) therebetween substantially filled with a transparent material, such as air, for instance. In other instances, the slots (70) between the slats (60) may be filled with any transparent material having a refractive index close to 1.

In some embodiments as shown in FIG. 8, the glare trap (30) may further include a frame (100). The slats (60) in the plurality of spaced apart substantially parallel slats may be at least partially disposed inside (101), and at least partially surrounded by the frame (100). In some aspects, opposite longitudinal ends (61, 62) of each of the slats (60) may be secured to the frame (100) under tension. Securing the slats (60) to the frame (100) under tension reduces sag over time and retains the shape of the glare trap, which becomes important especially when dealing with high temperature changes.

Referring to FIG. 16, in other embodiments, the glare trap (30c) may further include a frame (150) having opposing top (151) and bottom (152) frame portions assembled to each other. At least portions of the solid perimeter portion of the metal sheet (140) of the glare trap (30c) may be secured between the opposing top (151) and bottom (152) frame portions. Each of the top and bottom frame portions (151, 152) has an interior cut-out portion (153) exposing the slats (60) in the plurality of spaced apart substantially parallel slats.

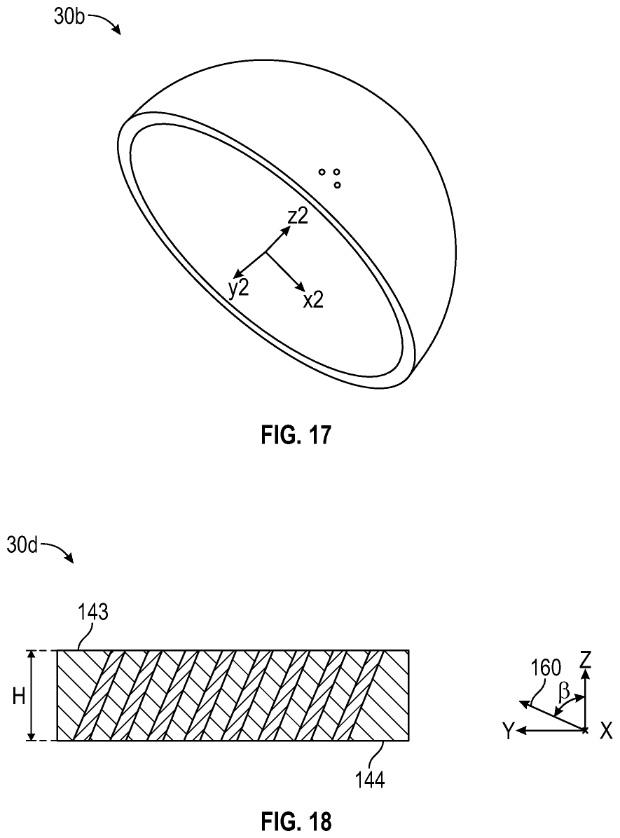

In some instances, the glare trap (30b) may be curved along at least one direction as shown in FIG. 17. In other embodiments shown in FIG. 18, the width direction (160) of the light control film (30d) may make an oblique angle (B) with the thickness direction (z-axis).

In some aspects, the slats (60) may be made from a material that has a diffuse surface with less than 4% reflection in order to keep the brightness of sunlight reflected from the slats (60) below 1000 cd/m², which is about 10% of the brightness of a typical HUD image under daylight driving conditions.

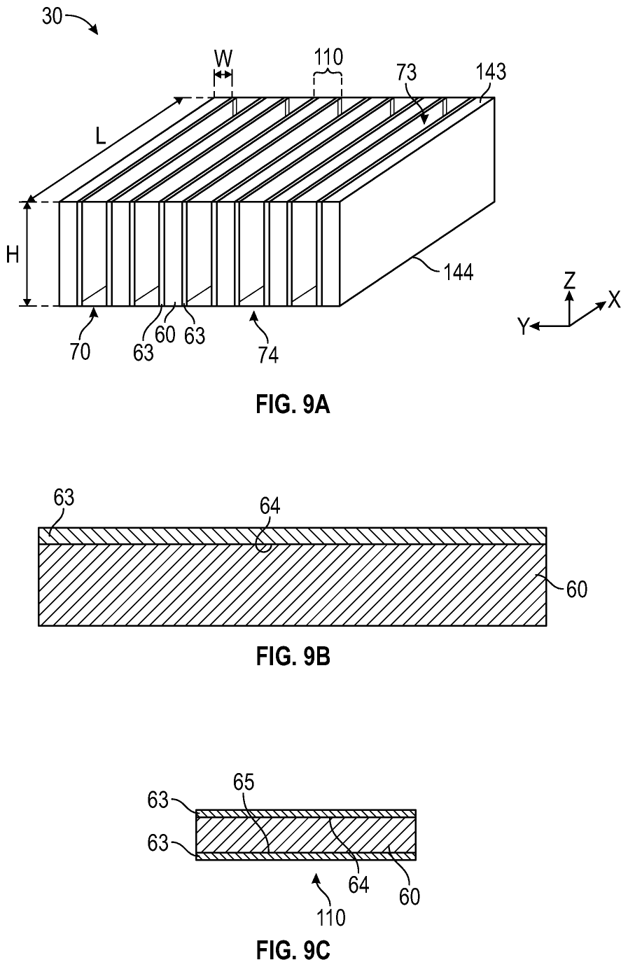

Referring to FIGS. 9A-9C, the light control film (30) according to some embodiments may include a plurality of spaced apart substantially parallel light blocking regions (110) extending along a first direction (x-axis) and arranged along an orthogonal second direction (y-axis). Each light blocking region (110) may include a metal slat (60) extending continuously along the length of the light blocking region (110). The metal slat has a length L along the first direction and a width W along a width direction (y-axis) of the metal slat, such that, in some cases, L/W≥10. The light blocking regions (110) form a plurality of elongated through slots (70) therebetween substantially filled with a transparent material, such as air, for instance. In this case the light control film may be referred to as an air louver. In other instances, the slots (70) between the metal slats (60) may be filled with any transparent material having a refractive index close to 1. The light control film (30) further includes a thickness H along a thickness direction (z-axis) thereof substantially orthogonal to opposing major surfaces (143, 144) of the light control film (30).

In some embodiments, the glare trap (30) may include a plurality of spaced apart substantially parallel metal slats (60) extending along a first direction (x-axis) and arranged along a different second direction (y-axis). Each slat (60) has a width W along the second direction and a thickness H along a third direction (z-axis) orthogonal to the first and second directions. In some instances, the thickness H (in mm) may not be greater than:

$$n \frac{3 \times 1 {0}^{- 4} \cdot D - W}{ϕ}$$

and, in other instances, H (in mm) may not be less than:

$$n \frac{W}{0.35}$$

where,
‘n’ is an index of refraction of a material substantially filling the spaces between the slats,
‘ϕ’ is a half of a field angle of an edge (41a) (FIG. 1) of the virtual image in units of radians,
‘D’ is the distance (in mm) propagated by the emitted image (40) along the optic axis (11) between the glare trap (30) and the viewer (50), and
‘W’ is the width of each slat (in mm)

In some instances, n may be less than 1.5, or less than 1.4, or less than 1.3, or less than 1.2, or less than 1.1. In some other instances, ϕ may be less than about 0.35 radians, or less than about 0.3 radians, or less than about 0.25 radians, or less than about 0.2 radians, or less than about 0.15 radians, or less than about 0.1 radians, or less than about 0.05 radians.

In some aspects, as best shown in FIG. 9B, at least one of the light blocking regions (110) may include a reflection reducing treatment (63) on at least a portion of a major surface (64) of the metal slat (60) of the light blocking region. In other aspects, as best shown in FIG. 9C, at least one of the light blocking regions (110) may include a reflection reducing treatment (63) on at least a portion of each of opposing major surfaces (64, 65) of the metal slat (60) of the light blocking region (110).

For instance, the reflection reducing treatment (63) may include an anti-reflection coating disposed on one or each of the major surfaces (64, 65). In some other instances, the reflection reducing treatment (63) may include a black coating disposed on one or each of the major surfaces (64, 65), or, in some instances, may include blackening one or each of the major surfaces (64, 65). In some other cases, the reflection reducing treatment (63) may include anodizing one or each of the major surfaces (64, 65). In other instances, the reflection reducing treatment (63) may include roughening one or each of the major surfaces (64, 65). For instance, roughening one or each of the major surfaces (64, 65) may include a wet chemical etching of one or each of the major surfaces (64, 65).

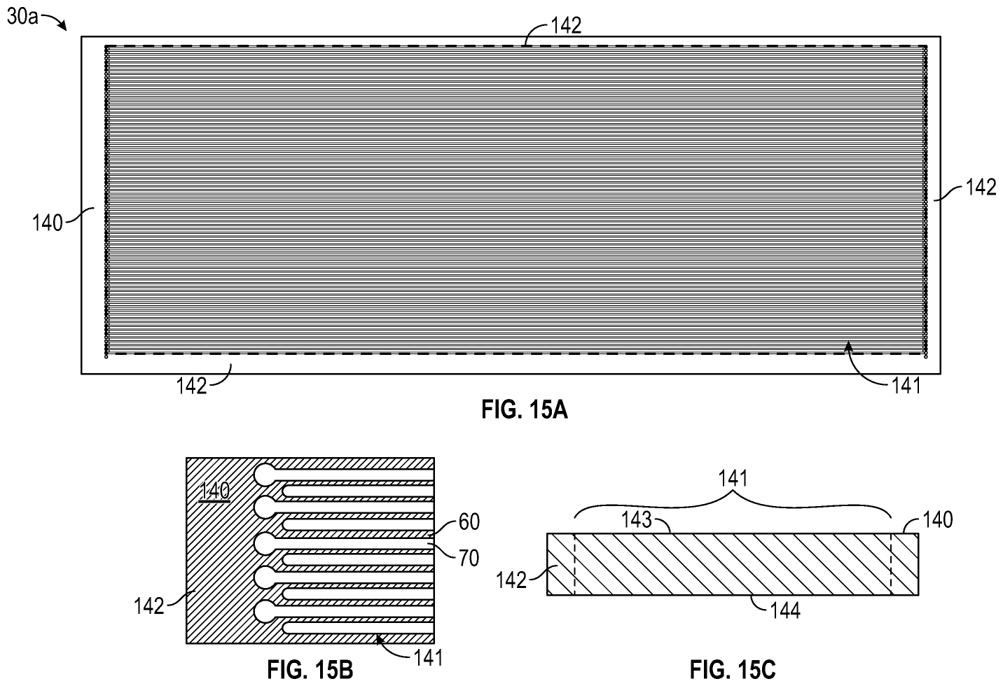

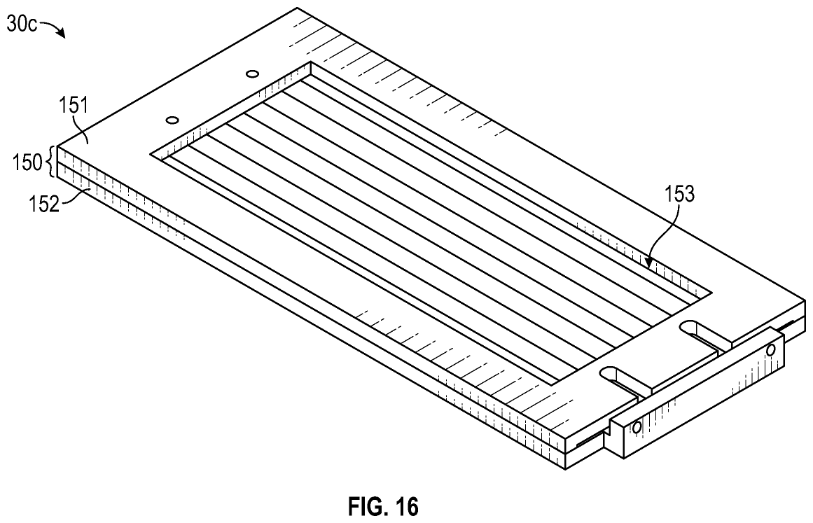

The construction of the glare trap (30a) according to some embodiments is best shown in FIG. 15A-15C. The glare trap (30a) may include a unitary metal sheet (140) having a plurality of alternating slats (60) and elongated through slots (70) formed in an inner portion (141) thereof. A solid perimeter portion (142) of the unitary metal sheet (140) substantially surrounds the plurality of alternating slats (60) and elongated through slots (70). Each elongated through slot (70) may extends between opposing major surfaces (143, 144) of the metal sheet. The slats (60) form the plurality of spaced apart substantially parallel slats of the glare trap (30). The metal may include one or more of steel, brass, bronze, iron, stainless steel, aluminum, copper, nickel, gold, zinc, and titanium.

A method of making the light control film (30, 30a) may include steps of providing a sheet of metal (140) having opposing top (143) and bottom (144) major surfaces and forming a plurality of spaced apart substantially parallel elongated through slots (70) in the sheet of metal. The plurality of spaced apart substantially parallel elongated through slots (70) in the metal sheet (140) may be formed by wire EDM (electrical discharge machining) process, for instance. In other instances, the elongated through slots (70) may be formed by at least one of grinding, etching, laser machining, ultrasonic machining, electrochemical machining, and stamping. The elongated through slots (70) may be formed to extend along a first direction (x) and may be arranged along an orthogonal second direction (v). Each elongated through slot (70) defines opposing top (73) and bottom (74) open surfaces at the respective opposing top (143) and bottom (144) major surfaces of the sheet of metal, as best shown in FIG. 9A.

### Example

A light control film (30, 30a) according to one or more embodiments was made by machining slots into a rolled steel plate having outside dimensions of 218 mm by 98 mm and a thickness of 1.2 mm. Slots were made parallel to the long axis of the plate by wire electro-discharge machining (EDM). The width of each slot was measured to be 0.3 mm and spaced apart by 0.45 mm from the adjacent slots, leaving a rib of metal 0.15 mm wide between each slot. Approximately 1655 slots were made to create a light control area that is 195 mm wide by 74 mm tall. The light control film (30) was surface treated to blacken the surface using TRU TEMP XL Low Temperature Black Oxide available from Birchwood Laboratories LLC, Eden Prairie, MN. The blackening process was carried out according to the manufacturers recommended process.

In some embodiments, for the incident angle (θ) of less than about 5 degrees as shown in FIG. 5, and for each of the first and second polarization states, the light control film (30) may have an average specular optical transmittance of between about 20% to about 80% and an average total optical reflectance of less than about 20%. In some instances, the average specular optical transmittance of the light control film (30) may be between 30% to about 80%, or between 30% to about 70%, or between 35% to about 70%, or between 40% to about 70%. In some instances, the average total optical reflectance of the light control film (30) may be less than about 15%, or less than about 10%, or less than about 5%, or less than about 4%, or less than about 3%, or less than about 2%.

In general, the optical measurements reported herein were made using conventional Lambda 1050 spectrophotometer. The angular measurements were taken using an ELDIM L80 Conoscope using the following method for measuring the luminance profile from a diffuse light source as described in WO2020121112.

A sample of film was placed on a Lambertian light source. An Eldim L80 conoscope (Eldim S. A., HEROUVILLE SAINT CLAIR. France) was used to detect light output in a hemispheric fashion at all polar and azimuthal angles simultaneously. The Lambertian light source consisted of diffuse transmission from a light box. The light box was a six-sided hollow cube measuring approximately 12.5 cm×12.5 cm×11.5 cm (L×W×H) made from diffuse polytetrafluoroethylene (PTFE) plates of approximately 6 mm thickness. One face of the box was chosen as the sample surface. The hollow light box had a diffuse reflectance of ˜0.83 measured at the sample surface (e.g. ˜ 83%, averaged over the 400-700 ran wavelength range). During testing, the box was illuminated from within through a ˜1 cm circular hole in the bottom of the box (opposite the sample surface, with the light directed toward the sample surface from inside). The illumination was provided using a LED light source attached to a fiber-optic bundle used to direct the light (Moritex A20980/3000K with a Moritex Straight Light Guide from Moritex North America. Inc., San Jose. CA).

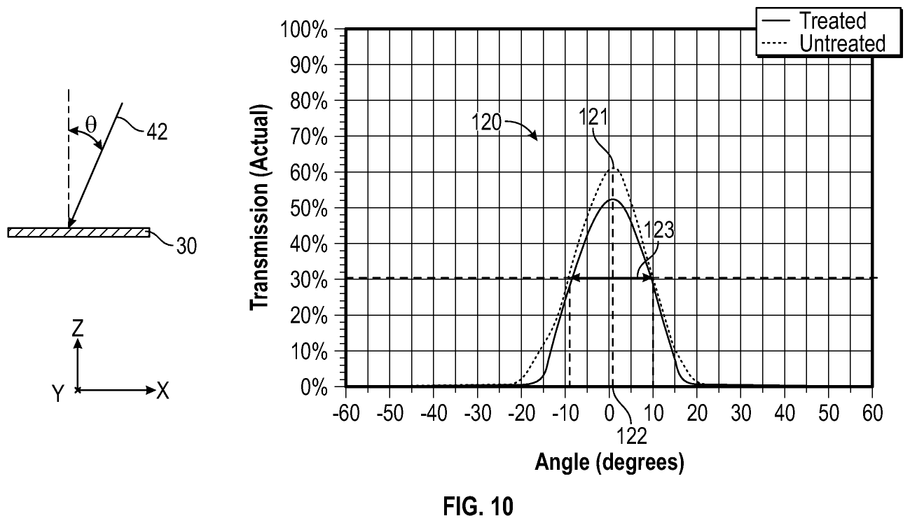

FIG. 10 shows an optical transmittance (120) of the light control film (30) versus the incident angle (θ) of light (42) incident on the light control film (30) in a plane of incidence (xz, yz-plane) substantially perpendicular to the first direction (x-axis). In some embodiments, for at least one wavelength in the visible wavelength range extending from about 420 nm to about 650 nm, the optical transmittance (120) of the light control film (30) may include a first transmittance peak (121) at a first peak angle (122) with a corresponding full width at half maximum (FWHM) (123) of less than about 30 degrees, or less than about 25, or less than about 20 degrees.

As shown in FIG. 11, for the at least one wavelength in the visible wavelength range extending from about 420 nm to about 650 nm, an optical transmittance (125) of the glare trap (30) versus the incident angle in a plane of incidence (yz-plane) substantially perpendicular to the second direction varies by less than about 15%, or by less than about 10%, or by less than about 7%, or by less than about 5% across at least a 30 degree, or 50 degree, or 70 degree, or 90 degree, or 110 degree, or 130 degree range of incident angles.

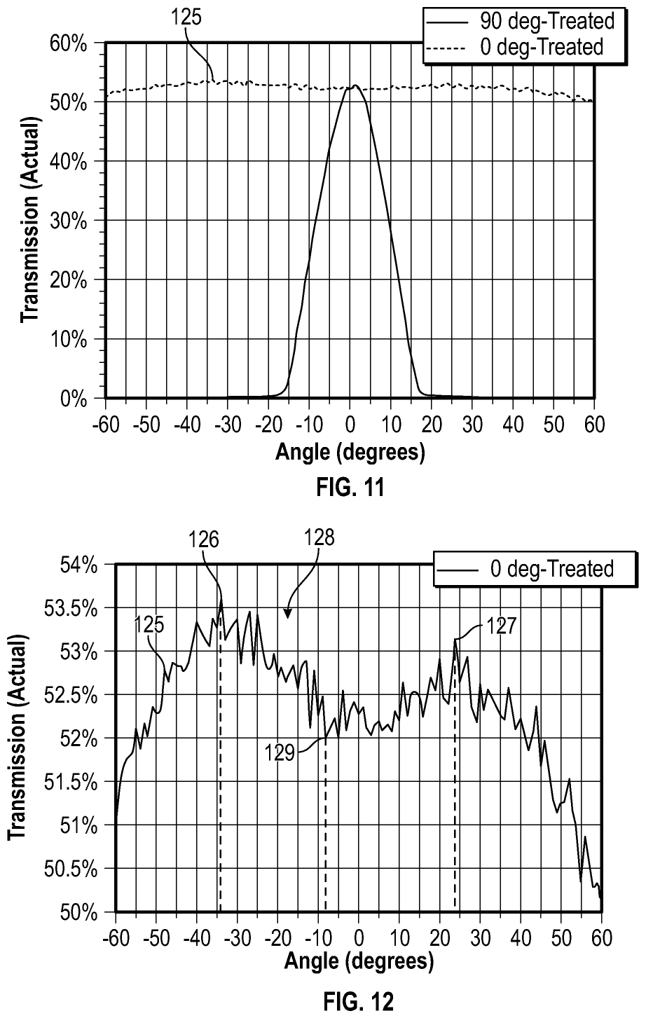

In other aspects as shown in FIG. 12 for the at least one wavelength in the visible wavelength range extending from about 420 nm to about 650 nm, an optical transmittance (125) of the glare trap (30) versus the incident angle in a plane of incidence (yz-plane) substantially perpendicular to the second direction may include first (126) and second (127) transmittance peaks separated by at least 30 degrees. The first and second peaks (126, 127) may define a transmittance valley (128) therebetween having a minimum transmittance (129) less than a greater of the first and second transmittance peaks by at least 1%, or by at least 1.25%, or by at least 1.5%.

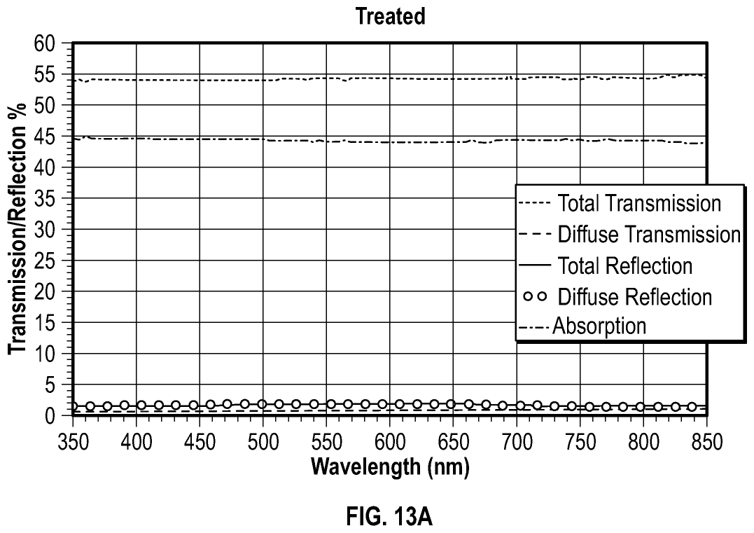

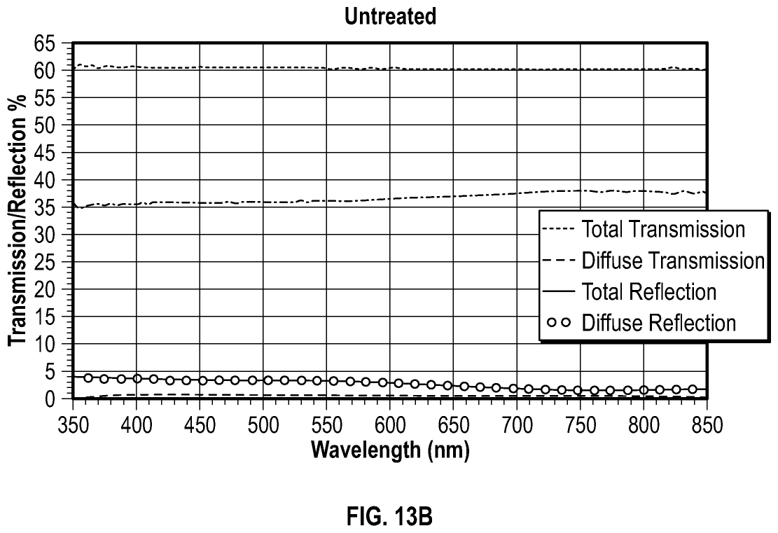

FIGS. 13A and 13B show the optical transmittance and optical reflectance of light control films with and without reflection reduction treatment, respectively, over a visible wavelength range. In some aspects, the glare trap (30) may have an average total optical transmittance of between about 20% to about 80%, or between 30% to about 80%, or between 30% to about 70%, or between 35% to about 70%, or between 40% to about 70%. In other aspects, the glare trap (30) may have an average diffuse optical transmittance of less than about 10%, or less than about 8%, or less than about 6%, or less than about 5%, or less than about 4%, or less than about 3%, or less than about 2%, or less than about 1%. In some other aspects, the glare trap (30) may have an average diffuse optical reflectance of less than about 20%, or less than about 15%, or less than about 10%, or less than about 5%, or less than about 4%, or less than about 3%, or less than about 2%. In some other aspects, the glare trap (30) may have an average specular optical reflectance of less than about 10% or less than about 8%, or less than about 6%, or less than about 5%, or less than about 4%, or less than about 3%, or less than about 2%, or less than about 1%, or less than about 0.5%. In other aspects, the glare trap (30) may have an average optical absorbance of less than about 60%, or less than about 55%, or less than about 50%, or less than about 45%, or less than about 40%.

Table 1 below shows the optical transmittance and optical reflectance of light control films having black coating as the reflection reducing treatment (63) over a visible wavelength range.

TABLE 1

| | Treated | | |
|---|---|---|---|
| | Average Transmission | Average Reflection | |
| | (420-650 nm) | (420-650 nm) | Absorption |
| Total | 53.96 | 1.87 | 44.17 |
| Diffuse | 0.89 | 1.87 | |
| Specular | 53.07 | 0.00 | |

Table 2 below shows the optical transmittance and optical reflectance of light control films without reflection reducing treatment over a visible wavelength range.

TABLE 2

| | Untreated | | |
|---|---|---|---|
| | Average Transmission | Average Reflection | |
| | (420-650 nm) | (420-650 nm) | Absorption |
| Total | 60.52 | 3.25 | 36.24 |
| Diffuse | 0.66 | 3.22 | |
| Specular | 59.85 | 0.03 | |

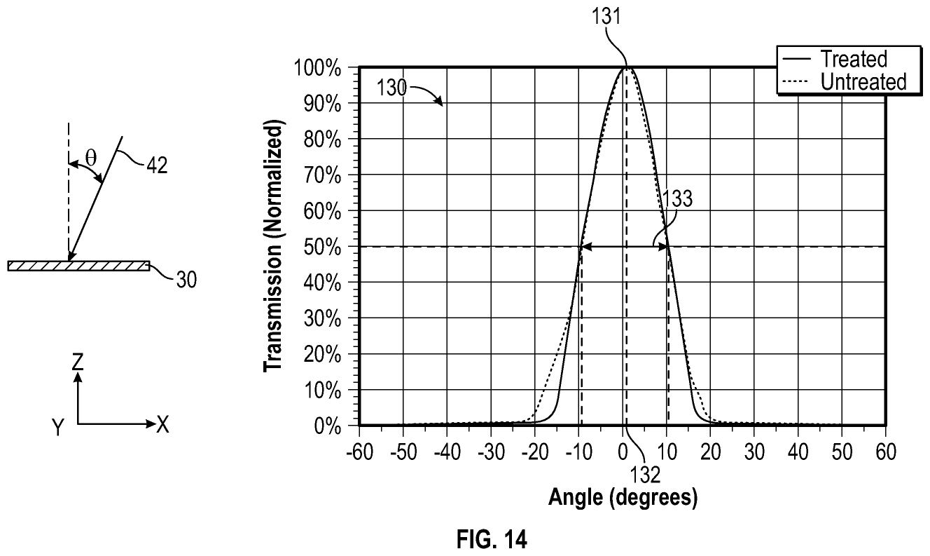

In other embodiments, best represented by FIG. 14, for the at least one wavelength in the visible wavelength range, a normalized optical transmittance (130) of the glare trap (30) versus the incident angle (0) may include a first normalized transmittance peak (131) at a first normalized peak angle (132) with a corresponding normalized full width at half maximum (NFWHM) (133) of less than about 30 degrees, or less than about 25, or less than about 20 degrees. In some aspects, the first normalized peak angle (132) may be less than about 30 degrees, or less than about 25 degrees, or less than about 20 degrees, or less than about 15 degrees, or less than about 10 degrees, or less than about 5 degrees.

1. An optical system comprising a display, a reflective polarizer, and a glare trap, the optical system configured to display a virtual image of an image emitted by the display to a viewer after the emitted image is transmitted by the glare trap and at least once reflected and at least once transmitted by the reflective polarizer, the glare trap comprising a plurality of spaced apart substantially parallel slats extending along a first direction and arranged along a different second direction, a length L along the first direction and a width W along the second direction, L/W≥10, wherein the slats in the plurality of spaced apart substantially parallel slats form a plurality of elongated slots therebetween substantially filled with air,
such that for a light incident at an incident angle and a visible wavelength range extending from about 420 nm to about 650 nm:
for the incident angle of less than about 5 degrees: the reflective polarizer has an average optical reflectance of at least 40% for the incident light having a first polarization state and an average optical transmittance of at least 40% for the incident light having an orthogonal second polarization state, and for each of the first and second polarization states, the glare trap has an average specular optical transmittance of between about 20% to about 80% and an average total optical reflectance of less than about 20%; and
for at least one wavelength in the visible wavelength range, an optical transmittance of the glare trap versus the incident angle in a plane of incidence substantially perpendicular to the first direction comprises a first transmittance peak at a first peak angle with a corresponding full width at half maximum (FWHM) of less than about 30 degrees.

2. The optical system of claim 1, wherein the glare trap further comprises a frame, the slats in the plurality of spaced apart substantially parallel slats at least partially disposed inside, and at least partially surrounded by the frame, wherein opposite longitudinal ends of each of the slats are secured to the frame under tension.

3. The optical system of claim 1, wherein the glare trap comprises a unitary metal sheet comprising a plurality of alternating slats and elongated through slots formed in an inner portion thereof leaving a solid perimeter portion substantially surrounding the plurality of alternating slats and elongated through slots, each elongated through slot extending between opposing major surfaces of the metal sheet, the slats forming the plurality of spaced apart substantially parallel slats of the glare trap.

4. The optical system of claim 1, wherein for the at least one wavelength in the visible wavelength range, an optical transmittance of the glare trap versus the incident angle in a plane of incidence substantially perpendicular to the second direction comprises first and second transmittance peaks separated by at least 30 degrees, the first and second peaks defining a transmittance valley therebetween having a minimum transmittance less than a greater of the first and second transmittance peaks by at least 1%.

5. The optical system of claim 1, wherein for the at least one wavelength in the visible wavelength range, a normalized optical transmittance of the glare trap versus the incident angle comprises a first normalized transmittance peak at a first normalized peak angle with a corresponding normalized full width at half maximum (NFWHM) of less than about 30 degrees.

6. A heads-up display (HUD) comprising:
the optical system of claim 1; and
a front windshield of a vehicle, such that when an image is emitted by the display, the optical system transmits the emitted image toward the front windshield, the front windshield reflects the transmitted image toward a viewer in the vehicle, and the viewer views a virtual image of the emitted image.

7. A light control film comprising a plurality of spaced apart substantially parallel light blocking regions extending along a first direction and arranged along an orthogonal second direction, each light blocking region comprising a metal slat extending continuously along the length of the light blocking region, the metal slat having a length L along the first direction and a width W along a width direction of the metal slat, L/W≥10,
wherein the light blocking regions form a plurality of elongated through slots therebetween substantially filled by air, and wherein for light incident on the light control film and for at least one wavelength in a visible wavelength range extending from about 420 nm to about 650 nm, an optical transmittance of the light control film versus an incident angle of the incident light in a plane of incidence substantially perpendicular to the first direction comprises a first transmittance peak at a first peak angle with a corresponding full width at half maximum (FWHM) of less than about 25 degrees.

8. A heads-up display (HUD) comprising:
a display, a reflective polarizer, and a glare trap, the HUD configured to display a virtual image of an image emitted by the display to a viewer after the emitted image is transmitted by the glare trap and at least once reflected and at least once transmitted by the reflective polarizer, the HUD comprising an optic axis extending between the display and the viewer, the glare trap configured to be positioned so that the emitted image propagates a distance D along the optic axis between the glare trap and the viewer, the glare trap comprising a plurality of spaced apart substantially parallel metal slats extending along a first direction and arranged along a different second direction, each slat comprising a width W along the second direction and a thickness H along a third direction orthogonal to the first and second directions, wherein H in units of mm is not greater than:
$$n \frac{3 \times 1 {0}^{- 4} \cdot D - W}{ϕ}$$
and is not less than:
$$n \frac{W}{0.35}$$
where n is an index of refraction of a material substantially filling the spaces between the slats, ϕ is a half of a field angle of an edge of the virtual image in units of radians, and D and W are in mm.

9. The HUD of claim 8 further comprising a second reflective polarizer configured to receive the transmitted image and reflect a portion of the received image toward the eye.

10. The HUD of claim 8, wherein ϕ is less than about 0.35 radians.
